(19) United States
(12) Patent Application Publication
(10) Pub. No.: US 2022/0217612 A1
(43) Pub. Date: Jul. 7, 2022

(54) COOPERATIVE COMMUNICATION FOR SIDELINK RELAY

(71) Applicant: Media Tek Singapore Pte. Ltd., Singapore (SG)

(72) Inventors: Xuelong Wang, Beijing (CN); Tao Chen, Beijing (CN)

(21) Appl. No.: 17/523,726

(22) Filed: Nov. 10, 2021

Related U.S. Application Data
(63) Continuation of application No. PCT/CN2019/120895, filed on Nov. 26, 2019.

(30) Foreign Application Priority Data
Nov. 26, 2019 (CN) PCT/CN2019/120895

(51) Int. Cl. H04W 40/22; H04W 28/02

(52) U.S. Cl. CPC H04W 40/22; H04W 92/18; H04W 28/0263

(57) ABSTRACT

Apparatus and methods are provided for cooperative communication for sidelink relay. In one embodiment, a plurality of sidelink relay paths are configured for an end-to-end communication path between two end nodes, a source node and a destination node, with one or more relay UEs. The source node or one or more intermediate relay node(s) within the sidelink relay path performs packet, segment, or radio bearer based cooperative communication at one protocol layer. The cooperative communication includes data duplication and data split depending on one or more factors. In one embodiment, the cooperative communication is supported by the weigh value transmission from the sender to the receiver node within the sidelink relay network. The weight value is statically configured or dynamically carried by an ACP control PDU. In one embodiment, the cooperative communication is supported by the redundant packets or segments removal at the intermediate relay node(s), and/or destination node.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2019/120895, titled “Methods and Apparatus of Cooperative Communication for Sidelink Relay,” with an international filing date of Nov. 26, 2019. This application is a continuation of International Application No. PCT/CN2019/120895. International Application No. PCT/CN2019/120895 is pending as of the filing date of this application, and the United States is an elected state in International Application No. PCT/CN2019/120895. The disclosure of each of the foregoing documents is incorporated herein by reference.

### TECHNICAL FIELD

The disclosed embodiments relate generally to wireless communication, and, more particularly, to cooperative communication for sidelink relay.

### BACKGROUND

5G radio access technology will be a key component of the modern access network. It will address high traffic growth and increasing demand for high-bandwidth connectivity. Wireless relay in cellular networks provides extended coverage and improved transmission reliability. Long term evolution (LTE) network introduced 3GPP sidelink, the direct communication between two user equipment (UEs) without signal relay through a base station. In 3GPP New Radio (NR), sidelink continues evolving. With new functionalities supported, the sidelink offers low latency, high reliability and high throughout for device-to-device communications. Using sidelink for wireless relay provides a reliable and efficient way for traffic forwarding. For the early sidelink-based wireless relay services, such as the ProSe UE-to-Network relay, the traffic between the remote UE and the base station is forwarded at the IP layer by the relay UE. The relay operation was specified for LTE aiming at coverage expansion from the perspective of Layer-3 (L3) relay. The Layer-2 (L2) based relay using sidelink can improve the efficiency and flexibility. The sidelink relay is further supported by integrated address backhaul (IAB) for the NR network to support packet routing and radio bearer mapping. The single path sidelink relay provides flexibility for coverage extension. As the NR network grows, the packet routing seeks more flexibility and reliability with cooperative communication functionalities.

Improvements and enhancements are required to use cooperative communication for the sidelink relay in the NR network.

### SUMMARY

Apparatus and methods are provided for cooperative communication for sidelink relay. In one embodiment, a plurality of sidelink relay paths are configured for an end-to-end communication path between two end nodes, a source node and a destination node, with one or more relay UEs. The source node or one or more intermediate relay node(s) within the sidelink relay path performs packet, segment, or radio bearer based cooperative communication at the ACP layer. The cooperative communication includes data duplication and data split depending on one or more factors including a QoS requirement, a radio signal strength measurement, a successful rate of packet transmission, a preconfigured rule, a status of flow control, packet feedback information, detecting of a topology change, and available radio resources. In one embodiment, at least one field is carried by the ACP layer comprising a sequence number (SN), a segment information (SI), and a segment offset (SO) when the cooperative communication is one selecting from packet-based split, packet-based duplication, packet-based split and duplication hybrid, segment-based split, segment-based duplication, and segment-based split and duplication hybrid.

In one embodiment, the cooperative communication is supported by the weigh value transmission from the sender to the receiver node within the sidelink relay network. The weight value is statically configured or preconfigured. In another embodiment, the weigh value is dynamically carried by an ACP control packet data unit (PDU). In one embodiment, the cooperative communication is supported by the redundant packets or segments removal at the intermediate relay node(s), and/or destination node.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary NR network with cooperative communication for the sidelink relay in accordance with embodiments of the current invention.

FIG. 2 illustrates an exemplary NR wireless system with centralized upper layers of the NR radio interface stacks in accordance with embodiments of the current invention.

FIG. 3 illustrates an exemplary diagram for the UE-to-Network relay with cooperative communication in accordance with embodiments of the current invention.

FIG. 4 illustrates an exemplary diagram for the UE-to-UE relay with cooperative communication in accordance with embodiments of the current invention.

FIG. 5 illustrates an exemplary diagram for the hybrid relay with cooperative communication in accordance with embodiments of the current invention.

FIG. 6A illustrates an exemplary user plane protocol stacks for relay path between the source end node and the destination end node with multiple relay UEs in accordance with embodiments of the current invention.

FIG. 6B illustrates an exemplary control plane protocol stacks for relay path between the source end node and the destination end node with multiple relay UEs in accordance with embodiments of the current invention.

FIG. 7 illustrates an exemplary ACP layer packet-based split for the communication path between one UE node and one peer UE node in accordance with embodiments of the current invention.

FIG. 8 illustrates an exemplary ACP layer packet-based duplication for the communication path between one UE node and one peer UE node in accordance with embodiments of the current invention.

FIG. 9 illustrates an exemplary ACP layer packet-based hybrid operation for the communication path between one UE node and one peer UE node in accordance with embodiments of the current invention.

FIG. 10 illustrates an exemplary ACP layer segment-based hybrid operation for the communication path between one UE node and one peer UE node in accordance with embodiments of the current invention.

FIG. 11 illustrates an exemplary ACP layer radio bearer based split operation for the communication path between one UE node and one peer UE node in accordance with embodiments of the current invention.

FIG. 12 illustrates exemplary diagrams for the detailed operations of the cooperative communication for the SL relay in accordance with embodiments of the current invention.

FIG. 13 illustrates an exemplary flow chart for the cooperative communication for the SL relay in accordance with embodiments of the current invention.

### DETAILED DESCRIPTION

Reference will now be made in detail to some embodiments of the invention, examples of which are illustrated in the accompanying drawings.

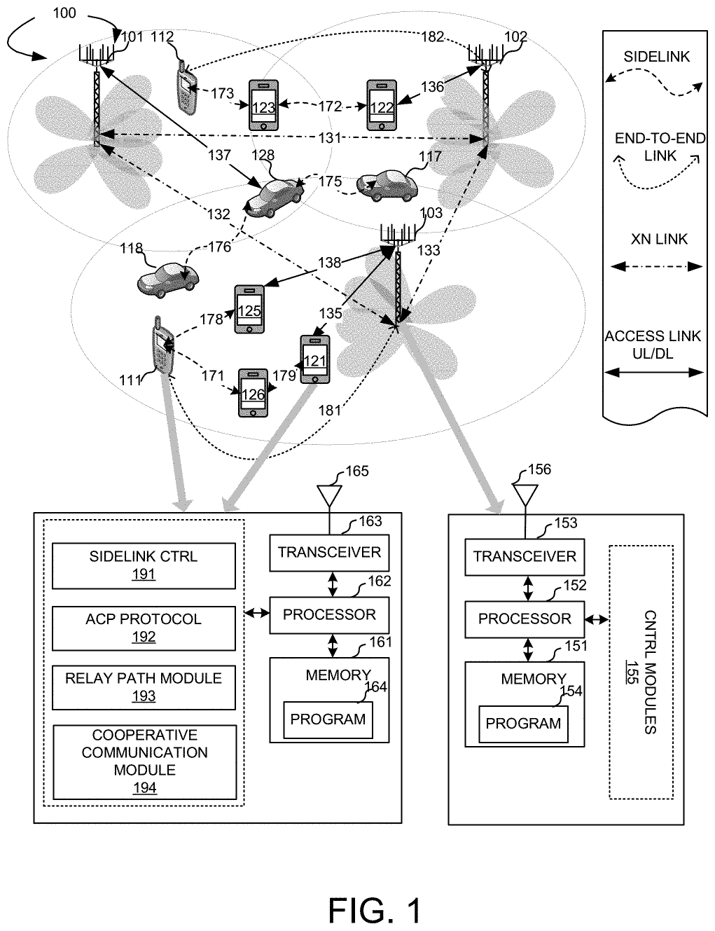

FIG. 1 is a schematic system diagram illustrating an exemplary NR network with cooperative communication for the sidelink relay in accordance with embodiments of the current invention. Wireless system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be a homogeneous network or a heterogeneous network, which can be deployed with the same frequency or different frequency. gNB 101, gNB 102 and gNB 103 are base stations in the NR network, the serving area of which may or may not overlap with each other. Backhaul connections such as 131, 132, and 133, connect the non-co-located receiving base units, such as gNB 101, 102 and 103. These backhaul connections can be either ideal or non-ideal. gNB 101 is connected with gNB 102 via Xn interface 131 and is connected with gNB 103 via Xn interface 132. gNB 102 is connected with gNB 103 via Xn interface 133.

Wireless network 100 also includes multiple communication devices or mobile stations, such user equipments (UEs) such as UEs 111, 112, 113, 117, 118, 121, 122, 123, 125, 126, and 128. Communication devices or mobile stations in wireless network 100 may also refers to devices with wireless connectivity in a vehicle, such as mobile devices 118, 117 and 128. The exemplary mobile devices in wireless network 100 have sidelink capabilities. The mobile devices can establish one or more connections with one or more base stations, such as gNB 101, 102, and 103. The mobile device may also be out of connection with the base stations with its access links but can transmit and receive data packets with another one or more other mobile stations or with one or more base stations through L2-based sidelink relay.

In one novel aspect, data packets are forwarded by one or more relay UEs with cooperative communication. A remote UE 111 and gNB 103 forms an end-to-end path 181 through a sidelink relay with cooperative communication with a relay UEs 121, 125, and 126. End-to-end path 181 between end nodes gNB 103 and remote UE 111 includes multiple relay paths. The first relay path includes an access link 135 between gNB 103 and relay UE 121, a sidelink link 179 between relay UE 121 and relay UE 126, and a sidelink 171 between remote UE 111 and relay UE 126. The second relay path configured and established for the end-to-end path 181 includes an access link 138 between gNB 103 and relay UE 125 and a relay link 178 between relay UE 125 and end-node UE 111. In another embodiment, the sidelink relay is a UE-to-Network multi-hop relay using sidelink configured. A remote UE 112 and gNB 102 forms an end-to-end path 182 through a sidelink relay with a relay UE 122 and another relay UE 123. End-to-end path 182 includes an access link 136 between gNB 102 and relay UE 122, sidelink 172 between relay UE 122 and relay UE 123, and sidelink 173 between remote UE 112 and relay UE 123. In yet another embodiment, a relay mobile device is configured with multiple remote mobile devices or multiple end node mobile devices. A relay UE 128, with an access link 137 to gNB 101 is configured with two remote UEs 117 and 118 through sidelink 175 and 176, respectively. In other embodiments, a relay mobile device can be configured for multiple UE-to-UE relay paths. Different links are established for the illustrated relay paths. An access link is a link between a base station, such as gNB and a mobile device, such as a UE. The UE can be a remote UE or a relay UE. The access link includes both the uplink (UL) and the downlink (DL) between the base station and the mobile device. The interface for the access link is an NR Uu interface. In one embodiment, the remote UE also establishes access link with a base station. A side link is a link between two mobile devices and uses PC5 interface. The sidelink can be a link between a remote UE/end-node UE and a relay UE or a link between two relay mobile devices/UEs for the multi-hop relay. The end-to-end link for a relay path can be a link between two end-node mobile devices for a UE-to-UE relay or a base station to mobile device for a UE-to-Network relay. An Xn link is the backhaul link between two base stations, such gNBs using the Xn interface.

In one novel aspect, a plurality of end-to-end relay paths are configured for a pair of end nodes including a source node and an end node UE. In one embodiment, the plurality of end-to-end relay paths include a plurality of relay links configured for a plurality of relay UE. The source node or the relay node performs packet or segment based cooperative communication at the ACP layer. The source node or the relay node UE performs cooperative communication to route data packets between the source node and the destination node UE, wherein cooperative communication includes an ACP layer function selecting from packet-based split, packet-based duplication, packet-based split and duplication hybrid, segment-based split, segment-based duplication, segment-based split and duplication hybrid, radio-bearer-based split, radio-bearer-based duplication, and radio-bearer-based split and duplication hybrid.

FIG. 1 further illustrates simplified block diagrams of a base station and a mobile device/UE for adaptation handling for cooperative communication for the sidelink relay. gNB 103 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 103. Memory 151 stores program instructions and data 154 to control the operations of gNB 103. gNB 103 also includes a set of control modules 155 that carry out functional tasks to communicate with mobile stations.

FIG. 1 also includes simplified block diagrams of a UE, such as relay UE 121 or remote UE 111. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for HF transmitting and receiving, and the other RF module is used for different frequency bands transmitting and receiving which is different from the HF transceiver. RF transceiver 163 also converts received baseband signals from processor 162, converts them to RF signals, and sends out to antenna 165. Processor 162 processes the received baseband signals and invokes different functional modules to perform features in THE UE. Memory 161 stores program instructions and data 164 to control the operations of the UE. Antenna 165 sends uplink transmission and receives downlink transmissions to/from antenna 156 of gNB 103.

The UE also includes a set of control modules that carry out functional tasks. These control modules can be implemented by circuits, software, firmware, or a combination of them. A sidelink controller 191 establishes one or SL in the wireless network. An adaptation control plane (ACP) protocol 192 configures an ACP layer on top of a radio link control (RLC) layer, wherein the ACP layer performs functions comprising radio bearer mapping, packet routing, and flow control. A relay path module 193 configures one or more SL relay paths, wherein the one or more SL relay paths is part of a plurality of end-to-end relay paths between a source node and a destination node UE with the relay UE being a relay node. A cooperative communication module 194 performs cooperative communication to route data packets between the source node and the destination node UE, wherein cooperative communication includes at least one of protocol layer functions packet-based split, packet-based duplication, packet-based split and duplication hybrid, segment-based split, segment-based duplication, segment-based split and duplication hybrid, radio-bearer-based split, radio-bearer-based duplication, and radio-bearer-based split and duplication hybrid.

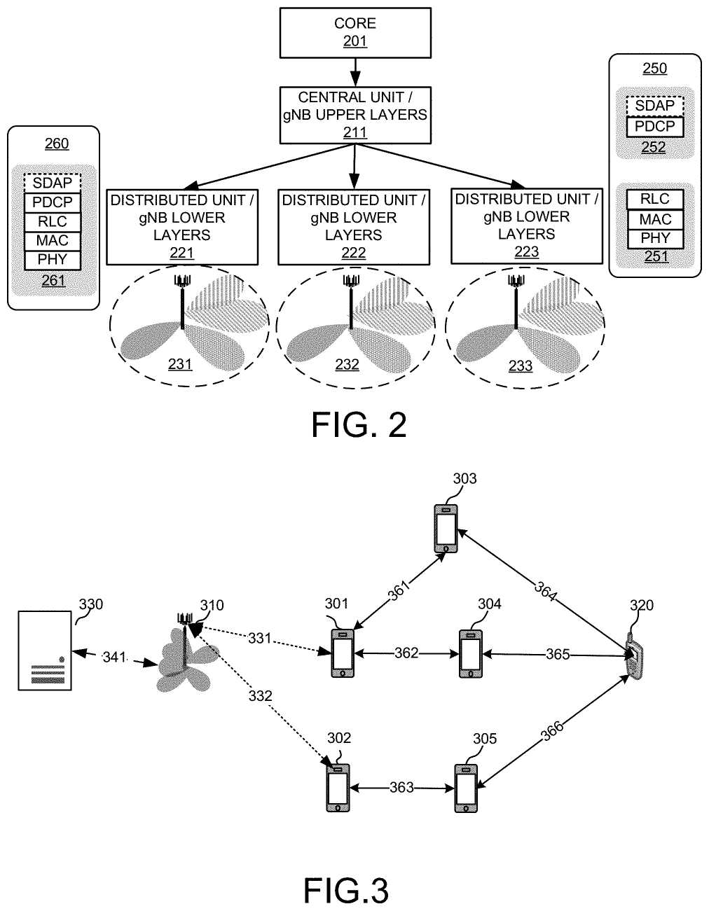

FIG. 2 illustrates an exemplary NR wireless system with centralized upper layers of the NR radio interface stacks in accordance with embodiments of the current invention. Different protocol split options between the central unit (CU) and the distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization, and jitter. In one embodiment, SDAP and PDCP layer are located in the CU, while RLC, MAC and PHY layers are located in the DU. A core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the RLC layers. In another embodiment 260, each gNB has the protocol stacks 261, including SDAP, PDCP, RLC, MAC and PHY layers.

FIG. 3 illustrates an exemplary diagram for the UE-to-Network relay with cooperative communication in accordance with embodiments of the current invention. In a NR network, a gNB 310 is connected with a core network 330. An end node UE 320 is configured to establish a plurality of relay path with one or more sidelink with gNB 310. gNB 310 is configured to be the relay node with additional mobile terminal functionality. In one novel aspect, cooperative communication is performed by one or mor relay nodes, such as UE 301, 302, 303, 304, and 305, configured with a plurality of end-to-end relay paths between the end nodes, which are gNB 310 and end node UE 320. The plurality of end-to-end relay paths includes Uu link and sidelink. In one embodiment, one or more intermedia relay node UEs, such as UE 303, 304, and 305, may also have Uu direct links with a gNB in the NR network. In another embodiment, one or more intermedia relay node UEs, such as UE 303, 304, and 305, and/or the end node UE 320 are out-of-coverage UEs. The end-to-end UE-to-network communication path includes three relay paths. A first relay path includes a Uu link 331 between gNB 310 and relay UE 301, a sidelink 361 between relay UE 301 and relay UE 303, and a sidelink 364 between relay UE 303 and end node UE 320. A second relay path includes a Uu link 331 between gNB 310 and relay UE 301, a sidelink 362 between relay UE 301 and relay UE 304, and a sidelink 365 between relay UE 304 and end node UE 320. A third relay path includes a Uu link 332 between gNB 310 and relay UE 302, a sidelink 363 between relay UE 302 and relay UE 305, and a sidelink 366 between relay UE 305 and end node UE 320. In one embodiment, the cooperative functions are performed at the ACP layer of the relay UE. In another embodiment, the cooperative functions are performed at the source node.

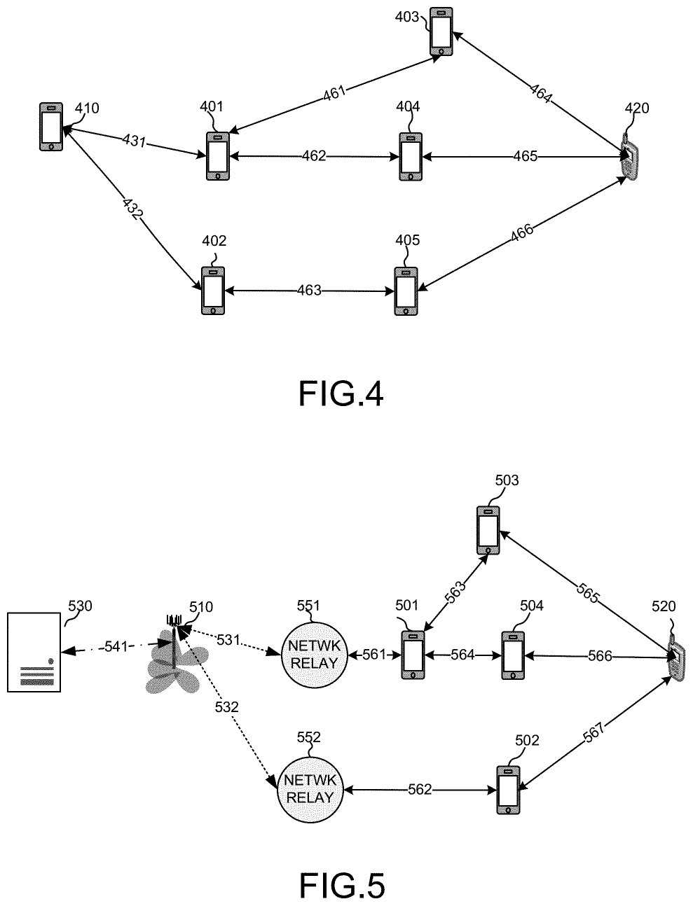

FIG. 4 illustrates an exemplary diagram for the UE-to-UE relay with cooperative communication in accordance with embodiments of the current invention. A destination node/end node UE 420 is configured to establish a plurality of relay path with one or more sidelink with source node UE 410. In one novel aspect, cooperative communication is performed by one or mor relay nodes, such as UE 401, 402, 403, 404, and 405, configured with a plurality of end-to-end relay paths between the end nodes, which are source node UE 410 and destination node/end node UE 420. In one embodiment, one or more intermedia relay node UEs, such as UE 401, 402, 403, 404, and 405, also have Uu direct links with a gNB in the NR network. In another embodiment, one or more intermedia relay node UEs, such as UE 401, 402, 403, 404, and 405, and/or the end nodes UE 410 and 420 are out-of-coverage UEs. The exemplary end-to-end UE-to-UE communication path includes three relay paths. A first relay path includes a relay link 431 between source node UE 410 and relay UE 401, a sidelink 461 between relay UE 401 and relay UE 403, and a sidelink 464 between relay UE 403 and end node UE 420. A second relay path includes relay link 431 between source node UE 410 and relay UE 401, a sidelink 462 between relay UE 401 and relay UE 404, and a sidelink 465 between relay UE 404 and end node UE 420. A third relay path includes a relay link 432 between source node UE 410 and relay UE 402, a sidelink 463 between relay UE 402 and relay UE 405, and a sidelink 466 between relay UE 405 and end node UE 420. In one embodiment, the cooperative functions are performed at the ACP layer of the relay UE. In another embodiment, the cooperative functions are performed at the source node.

FIG. 5 illustrates an exemplary diagram for the hybrid relay with cooperative communication in accordance with embodiments of the current invention. In a NR network, a gNB 510 is connected with a core network 530. A destination end node UE 520 is configured to establish a plurality of relay path with one or more sidelink with gNB 510. gNB 510 is configured to be the relay node with additional mobile terminal functionality. The relay path is configured with the hybrid relay network with integration of both network relay with network relay nodes 551 and 552 connecting with gNB 510 through links 531 and 532, respectively. The hybrid relay path also includes UE relay nodes such as UE 501, 502, 503, and 504. In one novel aspect, cooperative communication is performed by one or mor relay nodes, such as UE 501, 502, 503, and 504, configured with a plurality of end-to-end relay paths between the end nodes, which are gNB 510 and end node UE 520. The plurality of end-to-end relay paths includes Uu link and sidelink. In one embodiment, one or more intermedia relay node UEs, such as UE 501, 502, 503, and 504, also have Uu direct links with a gNB in the NR network. In another embodiment, one or more intermedia relay node UEs, such as UE 501, 502, 503, and 504, and/or the end node UE 320 are out-of-coverage UEs. The end-to-end UE-to-network communication path includes three relay paths. A first relay path includes a link 531 between gNB 510 and network relay note 551, a link 561 between network node 551 and relay UE 501, a sidelink 563 between relay UE 501 and relay UE 503, and a sidelink 565 between relay UE 503 and end node UE 520. A second relay path includes a link 531 between gNB 510 and network relay note 551, a link 561 between network node 551 and relay UE 501, a sidelink 564 between relay UE 501 and relay UE 504, and a sidelink 566 between relay UE 504 and end node UE 520. A third relay path includes a link 532 between gNB 510 and network relay note 552, a link 563 between network node 553 and relay UE 503, a sidelink 567 between relay UE 502 and end node UE 520. In one embodiment, the cooperative functions are performed at the ACP layer of the relay UE. In another embodiment, the cooperative functions are performed at the source node.

In one embodiment, the cooperative communication is performed by the ACP layer of the relay UE. The ACP layer performs one or more functions including data split and data duplication based on the relay path configuration.

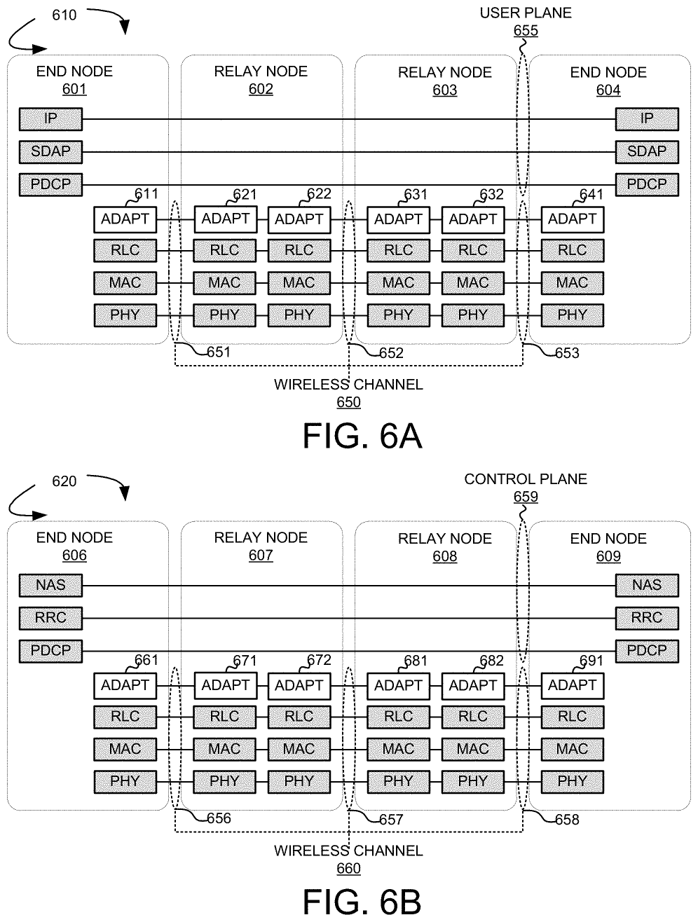

FIG. 6A illustrates an exemplary user plane protocol stacks for relay path between the source end node and the destination end node with multiple relay UEs in accordance with embodiments of the current invention. An exemplary relay path stack 610 includes stack of a source end node 601, stack of a destination end node 604, and stacks of two relay nodes 602 and 603. The source end node 601 and the destination end node 604 are the origination and destination nodes of the relay path. The origination and the destination nodes are also called the end-nodes. The lower layer wireless channel 650 is established through the PHY, MAC, RLC and ADAPT layers of each node on the relay path. A first wireless link 651 is established between lower layer stack of source end node 601 and a first lower layer protocol stack of relay node 602. A second wireless link 652 is established between the second lower layer protocol stack of relay node 602 and a first lower layer protocol stack of relay node 603. A second lower layer protocol stack of relay node 603 establishes a third wireless link 653 with lower layer protocol stack of destination end node 604. In one embodiment, for a UE-to-Network relay, the first wireless link 651 is an RLC wireless link through an Uu interface between relay node 602 and the source end node 601. In another embodiment, for a UE-to-UE relay, the first wireless link 651 is an RLC wireless link through an PC5 interface between relay node 602 and the source end node 601. The lower layer link between relay node 602 and 603 is a sidelink channel. The lower layer link between relay node 603 and destination end node 605 is a sidelink. On the user plane, end-to-end protocol connection 655 is established directly between the protocol stacks at the IP layer, the SDAP layer and the PDCP layer of source end node 601 and destination end node 604. The ACP/ADAPT layer of each node is used for packet routing of the sidelink relay. In one embodiment, each relay node is configured with two ACP layer stacks. Relay node 602 has ADAPT 621 and 622. Relay node 603 has ADAPT 631 and 632. Each ACP stack of the one or more relay nodes is connected with an end-node ACP stack. ACP 621 of relay node 602 is connected with ACP 611 of end-node 601. ACP 632 of relay node 603 is connected with ACP 641 of destination end-node 604. In one novel aspect, the origination and relay nodes perform SN handling at the ACP layer. The relay nodes also perform bearer mappings at the ACP layer, such as ACP 621, 622, 631, and 632. Each ACP layer has an adaptation layer address (ALA).

FIG. 6B illustrates an exemplary control plane protocol stacks for relay path between the source end node and the destination end node with multiple relay UEs in accordance with embodiments of the current invention. An exemplary relay path stack 620 includes stack of a source end node 606, stack of a destination end node 609, and stacks of two relay nodes 607 and 608. The source end node 606 and the destination end node 609 are the origination and destination nodes of the relay path. The origination and the destination nodes are also called the end-nodes. The lower layer wireless channel 660 is established through the PHY, MAC, RLC and ADAPT layers of each node on the relay path. A first wireless link 656 is established between lower layer stack of source end node 606 and a first lower layer protocol stack of relay node 607. A second wireless link 657 is established between the second lower layer protocol stack of relay node 607 and a first lower layer protocol stack of relay node 608. A second lower layer protocol stack of relay node 608 establishes a third wireless link 658 with lower layer protocol stack of destination end node 609. In one embodiment, for a UE-to-Network relay, the first wireless link 656 is an RLC wireless link through an Uu interface between relay node 607 and the source end node 606. In another embodiment, for a UE-to-UE relay, the first wireless link 656 is an RLC wireless link through an PC5 interface between relay node 607 and the source end node 606. The lower layer link between relay node 607 and 608 is a sidelink channel. The lower layer link between relay node 608 and destination end node 609 is a sidelink. On the control plane, end-to-end protocol connection 659 is established directly between the protocol stacks at the NAS layer, the RRC layer and the PDCP layer of source end node 606 and destination end node 609. The ACP/ADAPT layer of each node is used for packet routing of the sidelink relay. In one embodiment, each relay node is configured with two ACP layer stacks. Relay node 607 has ADAPT 671 and 672. Relay node 608 has ADAPT 681 and 682. Each ACP stack of the one or more relay nodes is connected with an end-node ACP stack. ACP 671 of relay node 607 is connected with ACP 661 of end-node 606. ACP 682 of relay node 608 is connected with ACP 691 of destination end-node 609. In one novel aspect, the origination and relay nodes perform SN handling at the ACP layer. The relay nodes also perform bearer mappings at the ACP layer, such as ACP 671, 672, 681, and 682. Each ACP layer has an adaptation layer address (ALA).

In one novel aspect, the cooperative communication is performed for the sidelink relay. The relay UE performs cooperative communication to route data packets between the source node and the destination node UE. The cooperative communication includes an ACP layer function selecting from packet-based split, packet-based duplication, packet-based split and duplication hybrid, segment-based split, segment-based duplication, segment-based split and duplication hybrid, radio-bearer-based split, radio-bearer-based duplication, and radio-bearer-based split and duplication hybrid.

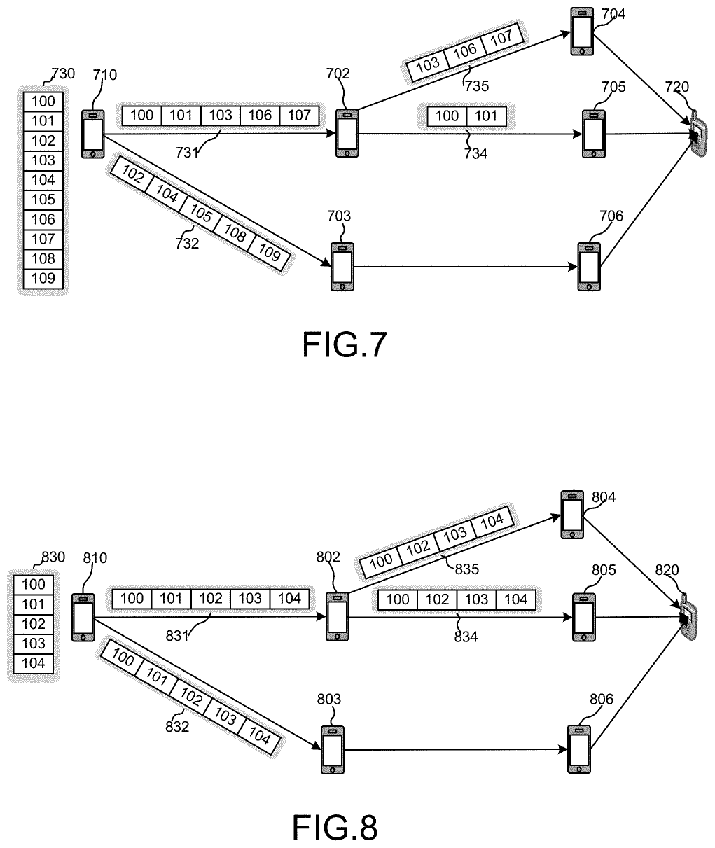

FIG. 7 to FIG. 11 illustrate exemplary scenarios for the ACP layer functions for the cooperative communication. FIG. 7 illustrates an exemplary ACP layer packet-based split for the communication path between one UE node and one peer UE node in accordance with embodiments of the current invention. In one embodiment, the ACP layer packet-based split is the SAP, also dentated as sidelink relay adaptation protocol (SRAP) layer packet-based split. Packet-based split is a specific mode of cooperative communication between the nodes within the relay network. The sequence number is inserted into the ACP header before the packet-based split at ACP layer for the same radio bearer. A plurality of relay paths is configured for relay communication path between the source node 710 and the destination end node UE 720 with relay UE 702, 703, 704, 705, and 706. Source node 710 has data packet 730 including #100 to #109. Source node packets 730 are split into packets 731 and 732. Packets 731 including #100, #101, #103, #106 and #107 are transmitted to relay UE 702 via the communication path between source end node UE 710 and relay UE 702. Packets 732 including #102, #104, #105, #108 and #109 are transmitted to relay UE 703 via the communication path between source end node 701 and relay UE 703. Relay UE 702 performs packet-based split upon receiving packets 731. Packet 731 is split into packets 735 and packets 734. Packets 735 including #103, #106 and #107 are transmitted to relay UE 704 via the communication path between relay UE 702 and relay UE 704. Packets 734 includes #100 and #101 are transmitted to relay UE 705 via the communication path between relay UE 702 and relay UE 705.

FIG. 8 illustrates an exemplary ACP layer packet-based duplication for the communication path between one UE node and one peer UE node in accordance with embodiments of the current invention. In one embodiment, the ACP layer packet-based duplication is the SRAP layer packet-based duplication. Packet based duplication is a specific mode of cooperative communication between the nodes within the relay network. The sequence number (SN) is inserted into the ACP header before the packet-based duplication at ACP layer for the same radio bearer. A plurality of relay paths is configured for relay communication path between the source node 810 and the destination end node UE 820 with relay UE 802, 803, 804, 805, and 806. Source node 810 has data packets 830 including #100 to #104. Source node packets 830 are duplicated into packets 831 and 832 to send to different communication paths in a duplication manner. Packets 831 including #100, #101, #102, #103 and #104 are transmitted to both relay UE 802 and relay UE 803 from source end node 810 via different communication paths in a duplication manner. Relay UE 802 upon receiving packets 831 sends duplicated packets 835 and 834 to next hops. Packets 834 and 835 both includes #100, #102, #103 and #104, and are transmitted to both relay UE 804 and relay UE 805 from relay UE 802 via different communication paths in a duplication manner. As an example, packet #101 is lost over the communication path from source node 810 to relay UE 802.

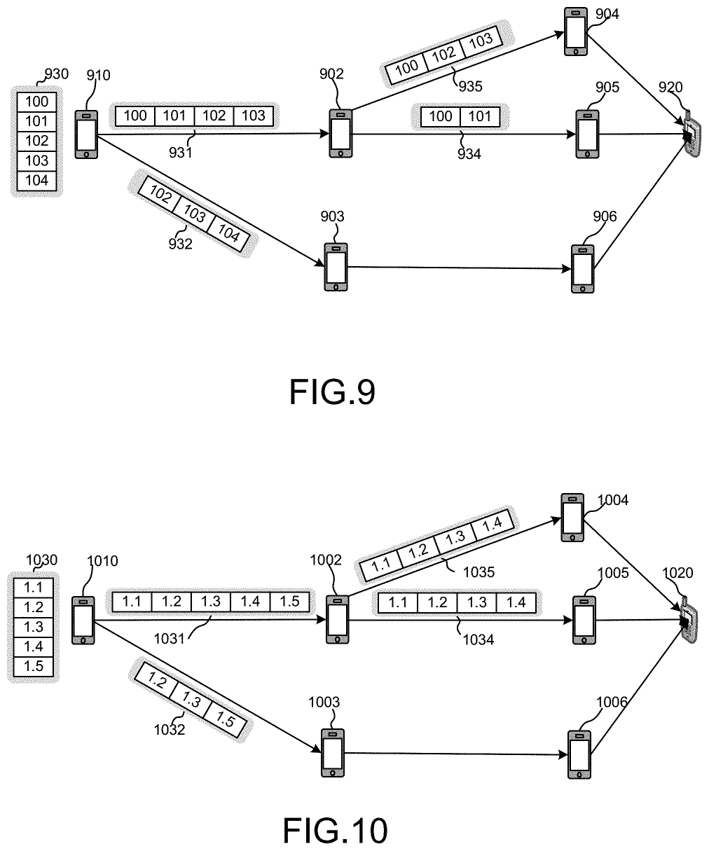

FIG. 9 illustrates an exemplary ACP layer packet-based hybrid operation for the communication path between one UE node and one peer UE node in accordance with embodiments of the current invention. In one embodiment, the ACP layer packet-based hybrid operation is SRAP layer packet-based hybrid operation. Packet based hybrid operation is a specific mode of cooperative communication between the nodes within relay network. The ACP layer packet-based hybrid operation includes both packet-based duplication and packet-based split. Some of the packets are duplicated and some of the packets are split in the different communication path depending on the need. The SN is inserted into the ACP header before the packet-based hybrid operation at ACP layer for the same radio bearer. A plurality of relay paths is configured for relay communication path between the source node 910 and the destination end node UE 920 with relay UE 902, 903, 904, 905, and 906. Source node 910 has data packets 930 including #100 to #104. Source node 910 performs hybrid packet-based operation for packets 930. Packets 930 is partially duplicated and split into packets 931 and 932. Packets 931 including #100, #101, #102, and #103 are transmitted to relay UE 902 via the communication paths from source end node 910 and relay UE 902. Packets 932, including #102 #103 and #104 are transmitted to relay UE 902 via relay path between source end node 910 and relay UE 903. As an example, packets 102 and 103 are duplicated. Relay UE 902 upon receiving packets, performs packet-based hybrid operation, and sends packets 935 and 934. Packets 935 including #100, #102, and #103, are transmitted to relay UE 904 via the communication paths from relay UE 902 to relay UE 904. Packets 934, including #100 and #101, are transmitted to relay UE 905 via the communication paths from relay UE 902 to relay UE 905. As an example, packet #100 Is duplicated.

FIG. 10 illustrates an exemplary ACP layer segment-based hybrid operation for the communication path between one UE node and one peer UE node in accordance with embodiments of the current invention. In one embodiment, the ACP layer segment-based hybrid operation is SRAP segment-based hybrid operation. Segment based hybrid operation is a specific mode of cooperative communication between the nodes within the relay network. The ACP layer segment-based hybrid operation includes both segment duplication and segment split. It means some of the segments are duplicated and some of the segments are split in the different communication path. The SN is inserted into the ACP segment header before the segment-based hybrid operation at ACP layer for the same radio bearer. A plurality of relay paths is configured for relay communication path between the source node 1010 and the destination end node UE 1020 with relay UE 1002, 1003, 1004, 1005, and 1006. Source node 1010 has data segments 1.1, 1.2, 1.3, 1.4, and 1.5 for data packet #1. Source node packets 1030 performs segment-based hybrid operation and sends packets 1031 and 1032. Packets 1031 includes segments 1.1, 1.2, 1.3, 1.4 and 1.5 (segmented from ACP packet #1) and are transmitted to relay UE 1002 via the communication paths from source end node 1010 and relay UE 1002. Packets 1032 includes segments 1.2, 1.3 and 1.5 (segmented from ACP packet #1) and are transmitted to relay UE 1003 via the communication paths from source end node 1010 and relay UE 1003. In this hop of transmission, only segments 1.2, 1.3 and 1.5 are duplicated. Relay UE 1002 performs segment-based hybrid operation and sends packets 1035 and 1034, which includes segments 1.1, 1.2, 1.3, and 1.4. Segments 1.1, 1.2, 1.3 and 1.4 are duplicated before they are transmitted to both relay UE 1004 and relay UE 1005 via different communication paths. As an example, segment 1.5 is lost over the communication path from source end node 1010 to relay UE 1002. In one embodiment, when segmentation applies to an ACP packet, the SI field is inserted into the header of the ACP segment to indicate whether the data packet contains a complete ACP service data unit (SDU) or the first, middle, last segment of an ACP SDU. When segmentation applies to an ACP packet, the SO field is inserted the header of the ACP segment to indicate the position of the RLC SDU segment in bytes within the original RLC SDU. The segmentation-based cooperative communication also includes segment-based data split only and segment-based data duplication only operations similar to those shown for the packet-based operations.

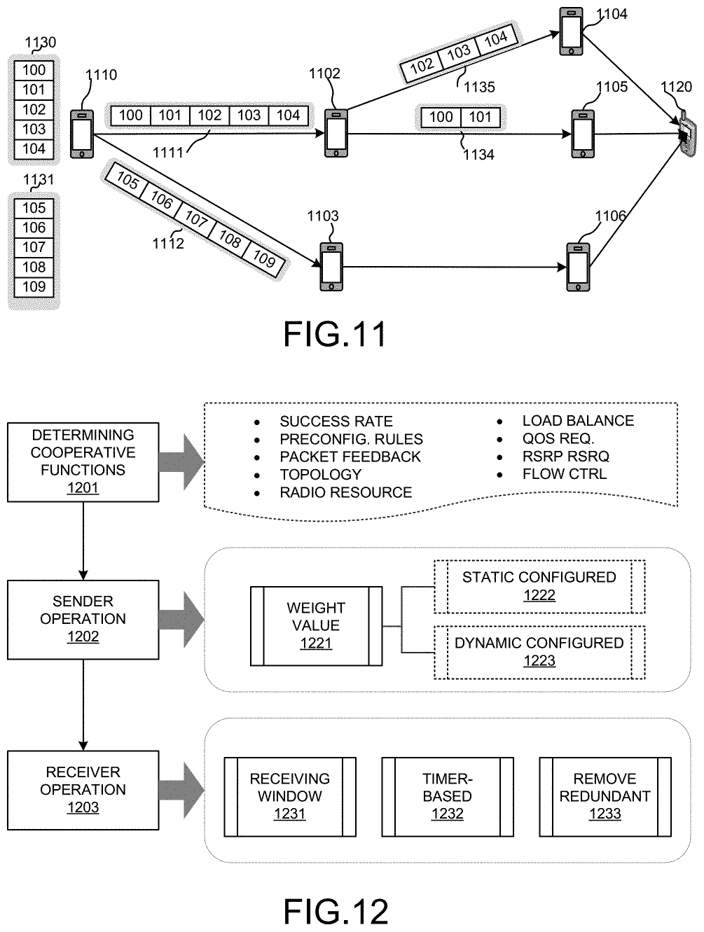

FIG. 11 illustrates an exemplary ACP layer radio bearer based split operation for the communication path between one UE node and one peer UE node in accordance with embodiments of the current invention. In one embodiment, the ACP layer radio bearer based split operation is SRAP radio bearer based split operation. Radio bearer-based hybrid operation is a specific mode of communication between the nodes within the relay network. ACP layer radio bearer-based operation includes both radio bearer split and radio bearer duplication. The radio bearer duplication is not shown. A plurality of relay paths is configured for relay communication path between the source node 1110 and the destination end node UE 1120 with relay UE 1102, 1103, 1104, 1105, and 1106. Source node 1110 has data packets 1130 including #100 to #104 from radio bearer #1 and data packets 1131 including #105 to #109 from radio bearer #2. The packets of a particular radio bearer can be duplicated in different communication path. In case of packet-based split, the granularity is per radio bearer, which means only the packets belong to different radio bearers can be split into a plural of data flows, with one corresponding to one communication path. Packets 1111, including #100 to #104 of the first radio bear are transmitted to relay UE 1102 from source end node 1110. Packets 1112 including #105 to #109 of the second radio bear are transmitted to relay UE 1103 from source end node 1110. The packets of first radio bearer are split in the second hop of the transmission. Relay UE 1102 splits the packets into packets 1135 and 1134. Packets 1135 includes #102, #103 and #104 of the first radio bear and are transmitted from relay UE 1102 to relay UE 1104. Packets 1134 includes #100 and #101 of the first radio bear and are transmitted from relay UE 1102 to relay UE 1105. Packets of the second radio bearer are transmitted from relay UE 1103 through relay UE 1106 to UE 1120.

FIG. 12 illustrates exemplary diagrams for the detailed operations of the cooperative communication for the SL relay in accordance with embodiments of the current invention. The source node and/or the relay node performs the data split, data duplication or hybrid operation for the relay data. The determination of the type of cooperative functions to perform, at step 1201, is based on one or more factors including a QoS requirement, a radio signal strength measurement, a successful rate of packet transmission, a preconfigured rule, a status of flow control, packet feedback information, detecting of a topology change, and available radio resources.

At step 1202, the sender of the data packets performs weight value operation as in 1221. The relay UE obtains a weight value configuration that includes a bitmap for each packet or segment flow to next hops in different relay paths, wherein the cooperative communication is performed based on the weight value. Within the relay communication path when one sender node decides the cooperative communication operation of the ACP packet or segment flow, such as, duplication or split. The sender codes the bitmap for each of the packet or segment flow in the different relay path. The bitmap is equivalent to the coding vector or weight value in network coding based cooperative communication in the art. For example, as shown in FIG. 11, there are five packets (i.e., #100, #101, #102, #103 and #104) at relay UE 1102 to be transmitted to the next hop. The weight value of the packets going to relay UE 1104 is W1=[0, 0, 1, 1, 1]; and the weight value of the packets going to relay UE 1105 is W2=[1, 1, 0, 0, 0]. The sender node sends the weigh value of a particular communication path to the receiver node within the relay network to allow the receiver node to adjust its receiving window for the particular data flow, such as packet flow, or segment flow. The receiver node slides the receiving window when receiving the packets or segments expected. In case there is a plural of receiving paths for a particular packet or segment flow, receiver node slides the receiving window when the expected packet or segment has already arrived at the receiving window. The receiver node does not wait for the duplicated packets or segments still flying. When the receiver node slides the receiving window, the receiver node can decide his cooperative communication operation on the packets or segments in the window (e.g., duplication or split) for its inferior hop transmission within the relay path. In one embodiment 1223, the weight value of the packet or segment flow for a particular relay path is transmitted by the sender of the packet flow via ACP layer control PDU to the receiver node of the packet flow. The ACP layer control PDU is used to enable dynamic transmission of the weight information (i.e., code vector). In one embodiment 1222, the weight information (i.e., code vector) is statically configured or pre-configured.

In one embodiment, the sender of the packet or segment flow relies on the receiver's acknowledgement and/or non-acknowledgement of the reception of ACP packets or segments to decide the need of retransmission. The receiver's acknowledgement and/or non-acknowledgement of a particular packet or segment is based on all of the available communication paths. This means if one packet or segment was correctly received by at least one the available communication path, the receiver feedbacks positive acknowledgement of the packet or segment to all of the senders per request.

At step 1203, the relay UE on the receiving side is configured with options of receiving window 1231, timer-based operation 1232, and removing redundant duplication operation 1233. In one embodiment 1231, the intermediate relay node runs a receiving window for the ACP layer data reception. In one embodiment, the window length is configured and is less than the half of the maximum of ACP layer SN. When all of the ACP packets or segments correctly arrive at the window, these ACP packets or segments is subject to further operation in the intermediate relay node (i.e., duplication or split) for its inferior hop transmission within the relay path. In one embodiment 1232, the intermediate relay node runs a timer for each packet or segment expected to receive. When the timer expires, the intermediate relay node gives up the packet or segment and performs its inferior hop transmission within the relay path for the packet flow when in-order packet forward is enabled at the intermediate relay node. In one embodiment 1233, the relay UE determines whether to remove the redundant duplicates. In one embodiment, the relay UE keeps redundant ACP layer packets or segments. The destination node UE removes redundant ACP layer packets or segments before delivering data packets to an upper layer of the destination node UE. In another embodiment, the relay UE removes redundant ACP layer packets or segments.

In one embodiment, the cooperative communication including both duplication and split based operation only occurs at the source node, and the intermediate Relay nodes supports transparent data forwarding. In this case, no duplication or split is performed for the received packet or segment flow in intermediate Relay nodes. The data flow is assembled at the destination node.

Though ACP layer operation for the cooperative communication of the SL relay is described, the same operation is performed at the RLC layer in other embodiments. the cooperative communication including both duplication and split based operation is performed at RLC layer of the source node or intermediate Relay Node. In this case, the data flow is RLC layer packets or RLC layer segments flow. Depending on the size of the MAC layer transmission block (i.e., TB) allocated for the inferior paths, the RLC packets can be segmented and put into different MAC entities of the inferior paths, with one segment mapped to a particular inferior path. The segmented RLC layer packets can be assembled at the intermediate Relay Node or at the destination node.

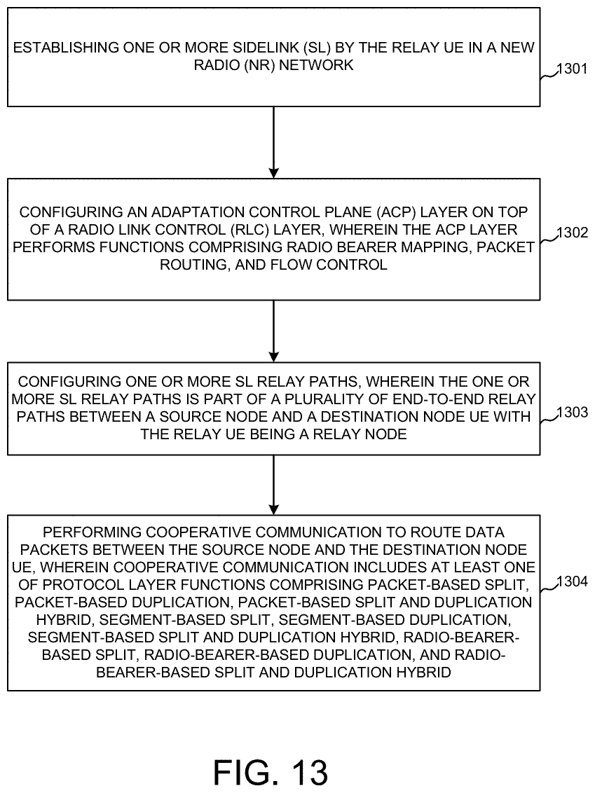

FIG. 13 illustrates an exemplary flow chart for the cooperative communication for the SL relay in accordance with embodiments of the current invention. At step 1301, the relay UE establishes one or more sidelink in the wireless network. At step 1302, the relay UE configures an adaptation control plane (ACP) layer on top of a radio link control (RLC) layer, wherein the ACP layer performs functions comprising radio bearer mapping, packet routing, and flow control. At step 1303, the relay UE configures one or more SL relay paths, wherein the one or more SL relay paths is part of a plurality of end-to-end relay paths between a source node and a destination node UE with the relay UE being a relay node. At step 1304, the relay UE performs cooperative communication to route data packets between the source node and the destination node UE, wherein cooperative communication includes an ACP layer function selecting from packet-based split, packet-based duplication, packet-based split and duplication hybrid, segment-based split, segment-based duplication, segment-based split and duplication hybrid, radio-bearer-based split, radio-bearer-based duplication, and radio-bearer-based split and duplication hybrid.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a relay user equipment (UE) comprising:
establishing one or more sidelink (SL) by the relay UE in a wireless network;
configuring an adaptation control plane (ACP) layer on top of a radio link control (RLC) layer, wherein the ACP layer performs functions comprising radio bearer mapping, packet routing, and flow control;
configuring one or more SL relay paths, wherein the one or more SL relay paths is part of a plurality of end-to-end relay paths between a source node and a destination node UE with the relay UE being a relay node; and
performing cooperative communication to route data packets between the source node and the destination node UE, wherein cooperative communication includes at least one of protocol layer functions comprising packet-based split, packet-based duplication, packet-based split and duplication hybrid, segment-based split, segment-based duplication, segment-based split and duplication hybrid, radio-bearer-based split, radio-bearer-based duplication, and radio-bearer-based split and duplication hybrid.

2. The method of claim 1, wherein at least one field is carried by the ACP layer comprising a sequence number (SN), a segment information (SI), and a segment offset (SO) when the cooperative communication is one of packet-based split, packet-based duplication, packet-based split and duplication hybrid, segment-based split, segment-based duplication, and segment-based split and duplication hybrid.

3. The method of claim 1, wherein cooperative communication is performed based on one or more factors comprising: a QoS requirement, a radio signal strength measurement, a successful rate of packet transmission, a preconfigured rule, a status of flow control, packet feedback information, detecting of a topology change, and available radio resources.

4. The method of claim 1, wherein the relay UE removes redundant ACP layer packets or segments.

5. The method of claim 1, wherein the relay UE keeps redundant ACP layer packets or segments.

6. The method of claim 1, further comprising obtaining a weight value configuration that includes a bitmap for each packet or segment flow to next hops in different relay paths, wherein the cooperative communication is performed based on the weight value configuration.

7. The method of claim 6, wherein the weigh value configuration is statically configured.

8. The method of claim 6, wherein the weight value configuration is dynamically carried by an ACP layer control packet data unit (PDU).

9. The method of claim 1, wherein the cooperative communication supports a window-based operation.

10. The method of claim 1, wherein the cooperative communication supports a timer-based operation.

11. A user equipment (UE), comprising:
a transceiver that transmits and receives radio frequency (RF) signal in a wireless network;
a sidelink (SL) controller that establishes one or SL in the wireless network;
an adaptation control plane (ACP) protocol that configures an ACP layer on top of a radio link control (RLC) layer, wherein the ACP layer performs functions comprising radio bearer mapping, packet routing, and flow control;
a relay path module that configures one or more SL relay paths, wherein the one or more SL relay paths is part of a plurality of end-to-end relay paths between a source node and a destination node UE with the relay UE being a relay node; and
a cooperative communication module that performs cooperative communication to route data packets between the source node and the destination node UE, wherein cooperative communication includes at least one protocol layer functions comprising packet-based split, packet-based duplication, packet-based split and duplication hybrid, segment-based split, segment-based duplication, segment-based split and duplication hybrid, radio-bearer-based split, radio-bearer-based duplication, and radio-bearer-based split and duplication hybrid.

12. The UE of claim 11, wherein at least one field is carried by the ACP layer comprising a sequence number (SN), a segment information (SI), and a segment offset (SO) when the cooperative communication is one of packet-based split, packet-based duplication, packet-based split and duplication hybrid, segment-based split, segment-based duplication, and segment-based split and duplication hybrid.

13. The UE of claim 11, wherein cooperative communication is performed based on one or more factors comprising: a QoS requirement, a radio signal strength measurement, a successful rate of packet transmission, a preconfigured rule, a status of flow control, packet feedback information, detecting of a topology change, and available radio resources.

14. The UE of claim 11, wherein the UE removes redundant ACP layer packets or segments.

15. The UE of claim 11, wherein the UE keeps redundant ACP layer packets or segments.

16. The UE of claim 11, further comprising obtaining a weight value configuration that includes a bitmap for each packet or segment flow to next hops in different relay paths, wherein the cooperative communication is performed based on the weight value configuration.

17. The UE of claim 16, wherein the weigh value configuration is statically configured.

18. The UE of claim 16, wherein the weight value configuration is dynamically carried by an ACP layer control-packet data unit (PDU).

19. The UE of claim 11, wherein the cooperative communication supports a window-based operation.

20. The UE of claim 11, wherein the cooperative communication supports a timer-based operation.
